(19) United States
(12) Patent Application Publication
(10) Pub. No.: US 2009/0119225 A1
(43) Pub. Date: May 7, 2009

(54) METHOD AND SYSTEM FOR PROVIDING A UNIFIED MODEL FOR CANDIDATE SERVICE ASSETS

(75) Inventors: RAPHAEL P. CHANCEY, Leander, TX (US); Eduardo T. Kahan, Longwood, FL (US)

Correspondence Address: IBM CORPORATION, (OLP);c/o ORTIZ & LOPEZ, PLLC, P.O. BOX 4484, ALBUQUERQUE, NM, 87196-4484, US

(73) Assignee: International Business Machines Corporation

(21) Appl. No.: 11/935,165

(22) Filed: Nov. 5, 2007

(51) Int. Cl. G06Q 40/00

(52) U.S. Cl. 705/36 R

(57) ABSTRACT

A computer-implementable method, system and computer-usable medium in which a unified model is utilized to provide candidate service assets. A plurality of assets can be presented to a user in association with a consistent set of properties that demonstrate how a particular asset among the assets Is composed. A single consolidated data model can then be processed that sufficiently describes the particular asset in a manner that provides sufficient information to the user to determine if the particular asset is a possible candidate for subsequent selection and action by the user, thereby permitting the user to perform decisions with respect to the particular asset with a minimal effort.

### TECHNICAL FIELD

Embodiments are generally related to data-processing systems and methods. Embodiments also relate in general to the field of computers and similar technologies, and in particular to software utilized in this field. In addition, embodiments relate to techniques and systems for providing asset information to users.

### BACKGROUND OF THE INVENTION

Information Technology (IT) has depended on target environments that were homogenous, reliable, secure, and centrally owned and managed. As the nature of business, government and other organizations evolves; however, marketing and asset allocation must be concerned with forming transient joint ventures to deliver “virtual products,” testing new products for marketplace viability, productizing as fast as possible for as little as possible, and delivering this amalgamation in what appears to be a “seamless” environment that always “knows the user.” At the same time, business must be concerned with maximizing use of IT resources to reduce total cost of ownership.

To meet these market requirements and business constraints, IT must now be concerned with asset collaboration and allocation, data sharing and resources across virtual organizations and environments; and the seamless delivery of product and service across virtual organizations and environments. Operations must be concerned with the management of increasingly complex computing environments. Outsourcing models began this transformation; economics and market pressures are pushing the transformation even further to the Utility Computing model. An additional force is also driving the need for automaton-level integration, the sheer numbers and speed at which heterogeneous pervasive computing devices are being introduced at the network edge.

These evolutionary pressures are generating new requirements for distributed application creation, execution and management environments and asset allocation. The utility computing model (resources on demand-soft and hard) mandates the synergistic operation of these trends. From an operational perspective, utility computing requires traditional off-line autonomous environments (creation, execution and management) to interact in near real time shifting from statically provisioned autonomous modules to systems that are dynamically provisioned across shared heterogeneous resources in response to real-time business needs, including the review, analysis and use of business and/or organizational assets.

Currently when existing assets are analyzed and presented to the user, they are done so with models specific to the user. The user must be well versed in the specific technology in order to understand how it can be converted to a service model, if even at all. Such an approach, while adequate for older IT implementations, is not seamless and suffers from inefficiencies and the ability to adapt to new IT models. Accordingly, to strategically align with business and organizational objectives with asset selection, allocation and distribution, an architecture is required that focuses on business asset allocation and which enables users to make asset decisions with minimal knowledge of the specific technologies utilized to store, distribute and allocate assets. It is believed that the embodiments disclosed herein offer a solution these problems.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for a method, system and computer-usable medium for providing candidate service assets.

It is an additional aspect of the present invention to provide for a consistent unified data model for providing service asset information and data to a user.

The aforementioned aspects and other objectives and advantages can now be achieved as described herein. A computer-implementable method, system and computer-usable medium are disclosed in which a unified model is utilized to provide candidate service assets. A plurality of assets can be presented to a user in association with a consistent set of properties that demonstrate how a particular asset among the assets is composed. A single consolidated data model can then be processed that sufficiently describes the particular asset in a manner that provides sufficient information to the user to determine if the particular asset is a possible candidate for subsequent selection and action by the user, thereby permitting the user to perform decisions with respect to the particular asset with a minimal effort.

The assets can be graphically presented to the user utilizing a display screen and preferably via a graphical user interface. The asset(s) can be automatically analyzed in response to a particular user input. Additionally, the graphical user interface can include a multi-pane view displayable within a display area of a display screen. The user can also be presented with a specification of the particular asset in order to assist the user in performing subsequent decisions with respect to the particular asset.

A single consolidated model can be thus created, which exposes the necessary information necessary to allow the user to determine if an asset is a possible candidate. This can enable decisions to be made with minimal deep knowledge of the specific technologies. In the case of a multi pane view, a bottom right pane, for example, can be provided as a tree decomposition of existing assets. These assets can be presented to the user with a consistent set of properties that sufficiently illustrate how the asset is composed, and the specification of the particular asset. This tooling would depend on a data model that can sufficiently describe the asset in a way that provides enough information.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1A illustrates a block diagram depicting an exemplary network in which a preferred embodiment of the present invention may be implemented;

FIG. 1B illustrates a more detailed block diagram depicting an exemplary server cluster in which a preferred embodiment of the present invention may be implemented;

FIG. 2 illustrates a block diagram depicting an exemplary data processing system in which a preferred embodiment of the present invention may be implemented;

FIG. 3 illustrates a high-level logical flowchart of operations illustrating an exemplary method of generating and processing a unified model for service candidate asset selection, in accordance with a preferred embodiment; and

FIG. 4 illustrates a GUI (graphical user interface) including a multi-pane view for presentation to a user, which can be implemented in accordance with an alternative embodiment.

### DETAILED DESCRIPTION

The particular values and configurations discussed in these non-limiting examples can be varied and are cited merely to illustrate at least one embodiment and are not intended to limit the scope of such embodiments.

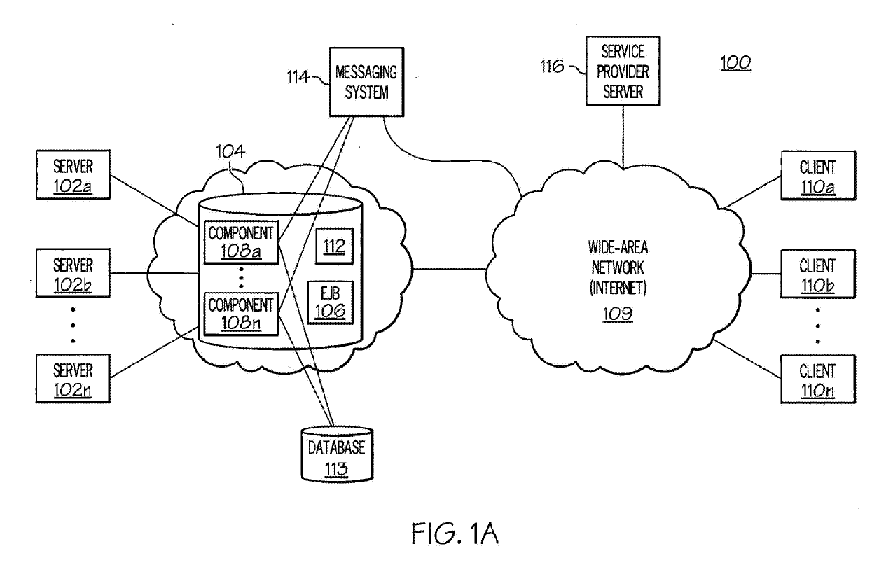

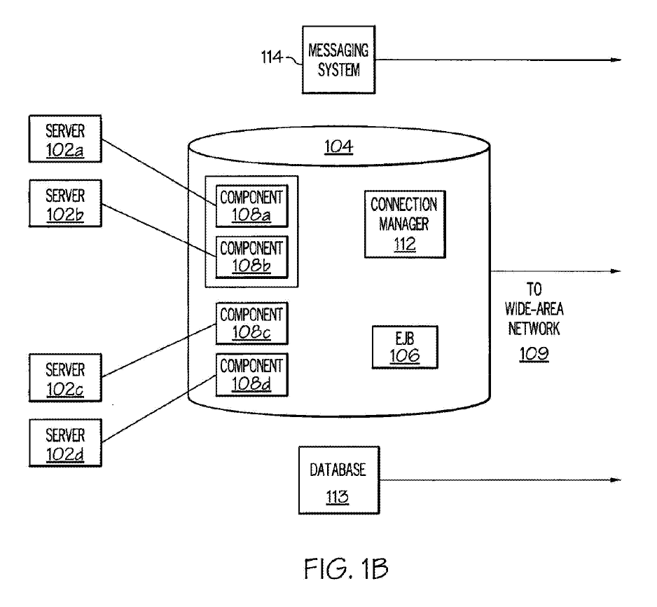

Referring now to the figures, and in particular, referring to FIG. 1A, there is illustrated a block diagram depicting an exemplary network 100 in which a preferred embodiment of the present invention may be implemented. As illustrated, network 100 includes a collection of servers 102a-n, server memory 104, wide-area network (WAN) 109, database 113, messaging system 114, and a collection of clients 110a-n. Clients 102a-n are preferably implemented as computers with access to WAN (e.g., Internet) 109 via a network interface adapter and seek to access a service provided by servers 102a-n. It can be appreciated that network 100 represents only one example, however, of any number of networks in which a preferred embodiment may be implemented. Thus, the embodiments discussed herein are not limited to the particular implementation of network 100.

Servers 102a-n access server memory 104, which may be implemented as a central or distributed memory. Server memory 104 includes a collection of components 108a-n, Enterprise Java Beans 106, and connection manager 112. Enterprise Java Beans 106 can define component architecture for deployable components (e.g., components 108a-n) and can dictate the rules for interaction between components 108a-n.

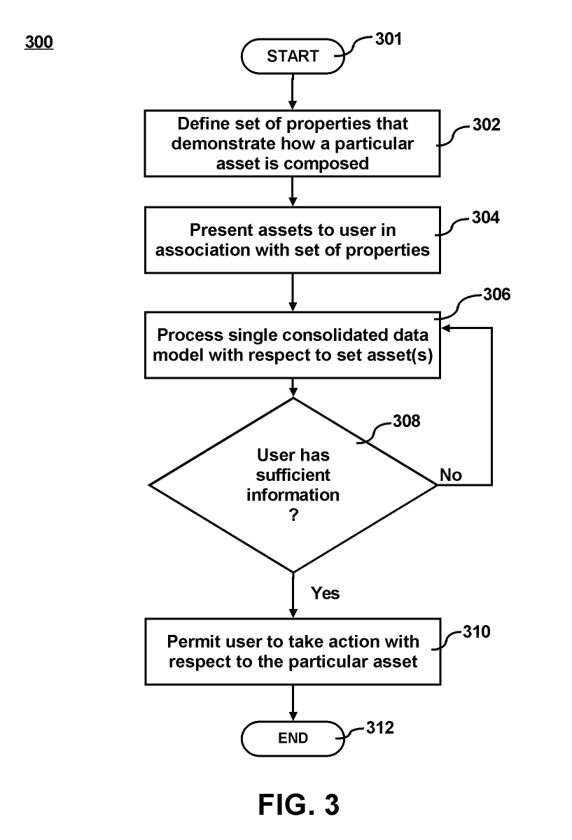

Components 108a-n are preferably implemented as code that implements a set of well-defined interfaces. Each component may be utilized by a system administrator as puzzle pieces to solve a larger problem. For example, an internet bookstore may utilize a first component as an interface for customers to input orders. An inventory component may interface with the first component to determine whether or not the orders can be filled. Connection manager 112, discussed herein in more detail in conjunction with FIG. 3, manages communication and responses to error messages between components 108a-n.

Database 113 and messaging system 114 can be implemented as external resources coupled to servers 102a-n. Database 113 may be utilized as a mass-storage server to store data generated by the processing performed by servers 102a-n. Messaging system 114, preferably implemented as Java™ Messaging Service (JMS), which can enable distributed objects (e.g., servers 102a-n and database 113) to communicate in an asynchronous, reliable manner.

FIG. 1B is a more detailed block diagram depicting the relationships between servers 102a-d and components 108a-d within server memory 104 according to a preferred embodiment. As illustrated, server 102a executes the code represented by component 108a, server 102b executes the code represented by component 108b, server 102c executes the code represented by component 108c, and server 102d executes the code represented by component 108d. Also, components 108a-b are preferably implemented as redundant components that share the same responsibilities. For example, if server 102a fails or goes offline for any reason, the responsibilities of component 108a are forwarded to component 108b until server 102a is brought back online. Conversely, components 102c-d can be implemented as stand-alone components in some embodiments. As previously discussed, messaging system 114 and database 113 can be utilized as external resources coupled to servers 102a-d.

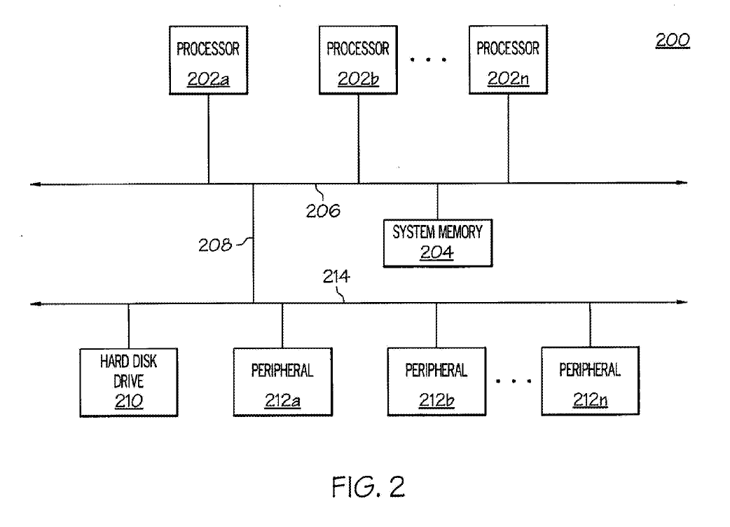

FIG. 2 illustrates a block diagram illustrating an exemplary data processing system 200 in which a preferred embodiment of the present invention may be implemented. Those with skill in the art will appreciate that data processing system 200 may be utilized to implement clients 102a-n. As depicted, exemplary data processing system 200 can include processing unit(s) 202, shown as processing units 202a and 202b in FIG. 2, which are coupled to system memory 204 via system bus 206. Preferably, system memory 204 may be implemented as a collection of dynamic random access memory (DRAM) modules. It can be appreciated that system 100 represents only one example, however, of any number of networks in which a preferred embodiment may be implemented. Thus, the embodiments discussed herein are not limited to the particular implementation of system 100.

Typically, system memory 204 can include data and instructions for running a collection of applications. A mezzanine bus 208 can act as an intermediary between system bus 206 and peripheral bus 214. Those with skill in this art will appreciate that peripheral bus 214 may be implemented as a peripheral component interconnect (PCI), accelerated graphics port (AGP), or any other peripheral bus. Coupled to peripheral bus 214 is hard disk drive 210, which is utilized by data processing system 200 as a mass storage device. Also coupled to peripheral bus 214 is a collection of peripherals 212a-n.

Those skilled in the art will appreciate that data processing system 200 can include many additional components not specifically illustrated in FIG. 2. Because such additional components are not necessary for an understanding of the present invention, they are not illustrated in FIG. 2 or discussed further herein. It should also be understood, however, that the enhancements to data processing system 200 for service candidate asset selection and allocation provided by the present invention are applicable to data processing systems of any system architecture and are in no way limited to the generalized multi-processor architecture or symmetric multi-processing (SMP) architecture illustrated in FIG. 2.

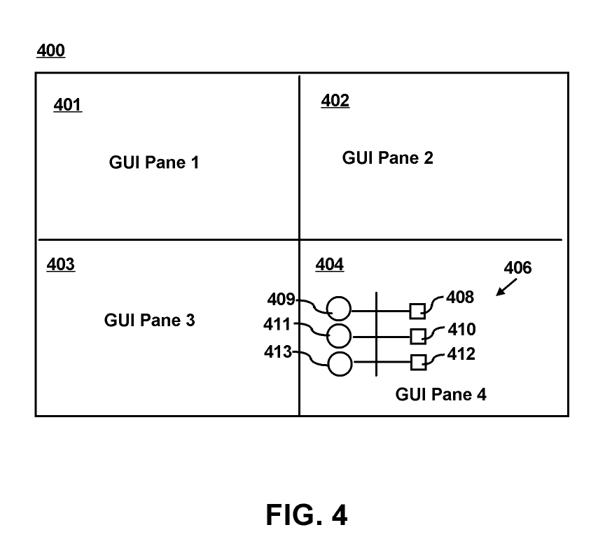

FIG. 3 illustrates a high-level logical flowchart of operations illustrating an exemplary method 300 of generating and processing a unified model for service candidate asset selection. The process generally begins, as indicated at block 301. Thereafter, as depicted at block 302, a consistent set of properties can be defined, which demonstrate how a particular asset among a group of assets is composed. Next, as illustrated at block 304, the group of assets (or a single asset) can be dynamically presented to the user in association with the consistent set of properties that demonstrate how the particular asset is composed. The presentation of such properties and assets can be provided via a GUI such as the GUI window illustrated in FIG. 4.

As depicted thereafter at block 306, a single consolidated data model can be processed, which sufficiently describes said particular asset in a manner that provides sufficient information to the user to determine if said particular asset is a possible candidate for subsequent selection and action by said user, thereby permitting said user to perform decisions with respect to said particular asset with a minimal effort. Next, as depicted at block 308, a test can be performed to determine if the user has the sufficient information necessary, as explained previously with respect to block 306. If so, then the process continues and as indicated at block 310, the user is permitted to take action (e.g., make a decision) with respect to the particular asset. The process can then terminate, as indicated at block 312.

As disclosed, the present invention generally includes a method, system, and computer-usable medium for presenting a plurality of assets to a user in association with a consistent set of properties that demonstrate how a particular asset among said plurality of assets Is composed; and processing a single consolidated data model that sufficiently describes said particular asset in a manner that provides sufficient information to said user to determine if said particular asset is a possible candidate for subsequent selection and action by said user, thereby permitting said user to perform decisions with respect to said particular asset with a minimal effort. Such an approach results in the creation of a single consolidated model that exposes information necessary to allow the user to determine if a particular asset is a possible candidate for further action by the user. This approach enables decisions to be made with minimal deep knowledge of the specific technologies involved.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent. The method described herein, and in particular as shown and described in FIG. 3, can be deployed as process software from service provider server 116 to servers 102a-n.

FIG. 4 illustrates a GUI implemented in the context of a multi-pane window 400 for presentation to a user, in accordance with an alternative embodiment. Note that as utilized herein, the terms “GUI” or “graphical user interface” can be utilized interchangeably, and refer generally to a graphical (rather than purely textual) user interface to a computer. A web browser, for example, is a GUI. A GUI involves the use of pictures rather than just words to represent the input and output of a program. A program with a GUI typically runs under some windowing system. The program displays certain icons, buttons, dialogue boxes etc. in its windows on the screen and the user controls it mainly by moving a pointer on the screen (typically controlled by a mouse) and selecting certain objects by pressing buttons on the mouse while the pointer is pointing at them. GUI window 400 can be displayed, for example, via a display screen/monitor in communication with, for example, bus 214 depicted in FIG. 2.

Window 400 includes one or more viewing panes 401, 402, 403, and 404. The bottom right pane 404 can include a tree decomposition 406 of existing assets 408, 410, and 412. These assets 408, 410 and 412 are presented to the user through the window 400 with a consistent set of respective properties 409, 411, 413 that sufficiently illustrate how a particular asset is composed, including the specification of the particular asset. This “tooling” can depend on a data model that sufficiently describes the asset in a manner that provides enough information for the use. Note that properties 409, 411, and 413 depicted in window 400 can be provided as graphical representations of data or data objects. That is, a user may select one or more properties 409, 411, 413 to view the data or data objects. Similarly, more information about a specific asset 408, 410 and/or 412 can be displayed for the user by selecting the graphical representation of such assets displayed within window pane 404.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer-implementable method, comprising:
dynamically presenting a plurality of assets to a user in association with a consistent set of properties that demonstrate how a particular asset among said plurality of assets Is composed; and
processing a single consolidated data model with respect to said plurality of assets, wherein said single consolidated data model describes said particular asset in a manner that provides sufficient information to said user to determine if said particular asset is a possible candidate for subsequent selection and action by said user, thereby permitting said user to perform decisions with respect to said particular asset with a minimal effort.

2. The computer-implementable method of claim 1 wherein presenting a plurality of assets to a user in association with a consistent set of properties that demonstrate how a particular asset among said plurality of assets Is composed further comprises:
graphically displaying said plurality of assets to said user utilizing a display screen.

3. The computer-implementable method of claim 1 wherein presenting a plurality of assets to a user in association with a consistent set of properties that demonstrate how a particular asset among said plurality of assets Is composed further comprises:
providing said plurality of assets to said user utilizing a graphical user interface.

4. The computer-implementable method of claim 1 further comprising automatically analyzing said plurality of assets in response to a particular user input.

5. The computer-implementable method of claim 1 further comprising automatically analyzing said particular asset among said plurality of assets in response to a particular user input.

6. The computer-implementable method of claim 3 wherein said graphical user interface comprises a multi-pane view displayable within a display area of a display screen.

7. The computer-implementable method of claim 1 wherein presenting a plurality of assets to a user in association with a consistent set of properties that demonstrate how a particular asset among said plurality of assets Is composed further comprises:
presenting to said user a specification of said particular asset in order to assist said user in performing subsequent decisions with respect to said particular asset.

8. The computer-implementable method of claim 1 further comprising:
defining said consistent set of properties prior to presenting said plurality of assets to said user in association with said consistent set of properties.

9. A system, comprising:
a processor;
a data bus coupled to said processor; and
a computer-usable medium embodying computer code, said computer-usable medium being coupled to said data bus, said computer program code comprising instructions executable by said processor and configured for:
dynamically presenting a plurality of assets to a user in association with a consistent set of properties that demonstrate how a particular asset among said plurality of assets Is composed; and
processing a single consolidated data model with respect to said plurality of assets, wherein said single consolidated data model describes said particular asset in a manner that provides sufficient information to said user to determine if said particular asset is a possible candidate for subsequent selection and action by said user, thereby permitting said user to perform decisions with respect to said particular asset with a minimal effort.

10. The system of claim 9, wherein said instructions are further configured for:
graphically displaying said plurality of assets to said user utilizing a display screen.

11. The system of claim 9, wherein said instructions are further configured for:
providing said plurality of assets to said user utilizing a graphical user interface.

12. The system of claim 9, wherein said instructions are further configured for:
automatically analyzing said plurality of assets in response to a particular user input.

13. The system of claim 9, wherein said instructions are further configured for:
automatically analyzing said particular asset among said plurality of assets in response to a particular user input.

14. The system of claim 11, wherein said graphical user interface comprises a multi-pane view displayable within a display area of a display screen.

15. The system of claim 9, wherein said instructions are further configured for:
presenting to said user a specification of said particular asset in order to assist said user in performing subsequent decisions with respect to said particular asset.

16. The system of claim 9, wherein said instructions are further configured for:
defining said consistent set of properties prior to presenting said plurality of assets to said user in association with said consistent set of properties.

17. A computer-usable medium embodying computer program code, said computer program code comprising computer executable instructions configured for:
dynamically presenting a plurality of assets to a user in association with a consistent set of properties that demonstrate how a particular asset among said plurality of assets Is composed; and
processing a single consolidated data model with respect to said plurality of assets, wherein said single consolidated data model describes said particular asset in a manner that provides sufficient information to said user to determine if said particular asset is a possible candidate for subsequent selection and action by said user, thereby permitting said user to perform decisions with respect to said particular asset with a minimal effort.

18. The computer-usable medium of claim 17, wherein said embodied computer program code further comprises computer executable instructions configured for:
graphically displaying said plurality of assets to said user utilizing a display screen.

19. The computer-usable medium of claim 17, wherein said embodied computer program code further comprises computer executable instructions configured for:
automatically analyzing said plurality of assets in response to a particular user input.

20. The computer-usable medium of claim 17, wherein said embodied computer program code further comprises computer executable instructions configured for:
presenting to said user a specification of said particular asset in order to assist said user in performing subsequent decisions with respect to said particular asset.
